(19) United States
(12) Patent Application Publication
(10) Pub. No.: US 2010/0063223 A1
(43) Pub. Date: Mar. 11, 2010

(54) COPOLYMER GRAFTED WITH POLYAMIDE, MATERIAL COMPRISING IT, PREPARATION PROCESS AND USES

(75) Inventors: Mathilde Weber, Gentilly (FR); Ilias Iliopoulos, Paris (FR); Ludwik Leibler, Paris (FR); Pierre Gerard, Denguin (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/516,934

(22) PCT Filed: Dec. 1, 2006
(86) PCT No.: PCT/FR2006/051271

§ 371 Date: May 29, 2009

(51) Int. Cl. C08L 53/00

(52) U.S. Cl. 525/92 R; 525/88; 525/94

(57) ABSTRACT

The invention relates to a graft copolymer composed of a block copolymer of general formula B-(A)ₙ in which A is a rigid block polymer with a glass transition temperature of more than 0° C., B is a flexible block polymer with a glass transition temperature of less than 0° C.; and n is 1 or is a natural integer greater than 1, it being possible for the blocks A, when n is 2 or more, to be identical or different; and of polyamide (PA) grafts which are carried by the rigid polymer block or blocks, the resulting graft copolymer being represented by the formula (A_{g})ₘ-B-(A)ₚ in which A and B are as defined above, A_{g} is the block A carrying at least one graft (PA) and m and p are natural integers whose sum is equal to n, but p being able to be equal to 0.

This application claims benefit, under U.S.C. §119 or §365 of PCT application PCT/FR2006/051271 filed Dec. 1, 2006.

The present invention relates to a graft copolymer comprising a flexible polymer block (which may also be called soft block) and at least one rigid polymer block (which may also be called a hard block), the rigid polymer block(s) carrying polyamide (PA) grafts. Such a graft copolymer is obtained by reacting, with a polyamide comprising an amine or acid end, a copolymer comprising the flexible polymer block and the rigid polymer block(s), this or these rigid polymer block(s) being functionalized. Advantageously, the graft copolymer is a copolymer of the hard-soft-hard type, the end blocks of which, in particular based on methyl methacrylate (MMA), carry the PA grafts.

According to the present invention, a material which has good thermomechanical properties and good chemical resistance, and also, under specific conditions, good transparency, is obtained.

Polymethyl methacrylate (PMMA) is a material which is appreciated for its excellent optical properties. It is, however, limited in terms of thermomechanical resistance since its glass transition temperature (denoted T_{g}) is 105° C. (for a PMMA obtained by radical polymerization). It is also limited in terms of stress-cracking strength. Research has made it possible to find a certain number of solutions for improving these performance levels. Thus, the copolymerization of methyl methacrylate (MMA) with methacrylic acid (MAA) can give copolymers having higher thermomechanical resistances; this is, for example, the Oroglas HT121 grade from the applicant. Mention may also be made of the method of imidization of PMMAs by reactive extrusion with an amine so as to give the materials known as Kamax® from the company Rohm and Haas. However, these solutions have limitations which exclude these methacrylic materials from applications which are particularly demanding from a chemical and/or thermal point of view.

### PRIOR ART

EP 0 500 361 A2 describes PMMA/PA alloys prepared using a graft copolymer obtained by melt-reacting a PMMA carrying glutaric anhydride functions and a polyamide terminated with an amine function as compatibilizing agent for a blend of PMMA and PA. The graft copolymer can be prepared in situ during the production of the alloy.

EP 0 438 239 A2 describes the use, as compatibilizing agent, of a graft copolymer obtained by melt-reacting a PMMA carrying glutaric anhydride functions and a polyamide.

EP 0 537 767 A1 describes a material obtained by reacting a PMMA carrying glutaric anhydride functions, a thermoplastic resin that may be a polyamide, and a copolymer carrying epoxide functions.

FR 2 868 785 A describes a graft copolymer comprising a PMMA backbone and polyamide grafts of number-average molecular mass between 1000 and 10 000 g/mol, and also a material comprising this graft polymer, which material exhibits both transparency and thermomechanical and chemical resistance.

The Applicant has now discovered that it is possible to obtain materials having an excellent compromise between the properties indicated above, by grafting polyamide onto a block copolymer, having a soft block and at least one hard block, in particular a soft-hard diblock or hard-soft-hard triblock copolymer or alternatively a star copolymer having a soft block as core and at least three hard blocks as arms, the hard blocks being functionalized as indicated in the subsequent text.

In particular, it emerged that copolymers used for grafting and exhibiting nanostructuring kept their nanostructuring after grafting. This is the case of the examples of hard-soft-hard copolymers illustrating the present invention. The term “nanostructured copolymers” or “nanostructured materials” is intended to mean blends of polymers which are stable and dispersed in domains having a size of generally less than 100 nm, preferably a few tens of nanometers. The consequence of this phenomenon is the production of graft copolymers which are very resistant to solvents and which have an improved thermomechanical resistance at high temperatures. It is, moreover, notable that the length of the grafts has no influence on the conservation of the nano structuring, as was the case in FR 2 868 785 A. Conversely, it appears that the properties are better for the longest grafts.

### BRIEF DESCRIPTION OF THE INVENTION

A first subject of the present invention is a graft copolymer composed of a backbone formed from a block copolymer of general formula:

B-(A)ₙ

in which:
A is a rigid polymer block with a glass transition temperature of more than 0° C.;
B is a flexible polymer block with a glass transition temperature of less than 0° C.; and
n is 1 or is a natural integer greater than 1,
   it being possible for the blocks A, when n is 2 or more, to be identical or different; and of polyamide (PA) grafts which are carried by the rigid polymer block(s), the resulting graft copolymer being represented by the general formula:

(A_{g})ₘ-B-(A)ₚ

in which:
A and B are as defined above;
A_{g} is the block A carrying at least one graft (PA); and
m and p are natural integers, the sum of which is equal to n, but it being possible for p to be equal to 0.

The term “identical blocks A” is intended to mean identical blocks of identical chemical nature since they are obtained from the same starting composition of monomers. In reality, as is well known to those skilled in the art, the composition and the molar mass of the blocks A indicated as identical may vary from one block A to another.

Another subject of the invention relates to the process for preparing the graft copolymer as defined above, characterized in that it consists in reacting, with a polyamide terminated with a primary-amine or acid function, a copolymer of general formula B-(A)ₙ, A, B and n being as defined above and the block(s) A carrying functionalities capable of reacting with primary-amine or acid functions of the polyamide.

Another subject of the invention relates to a material comprising the graft copolymer according to the invention.

Yet another subject of the invention relates to the use of the graft copolymer according to the invention or of the material comprising it.

### FIGURES

In the description of these figures and in the “examples” section hereinafter, the suffix “f” associated with the notation of a polymer block signifies that this block is functionalized, enabling it to react with the grafting polyamide.

FIGS. 1a and 1b are TEM micrographs of a functionalized triblock copolymer material P(MMA_{f}-b-BA-b-MMA_{f}) before the grafting of polyamide;

FIGS. 2a to 2c are TEM micrographs of the grafted triblock copolymer material obtained in example 2;

FIGS. 3, 5 and 7 each represent DMA storage modulus curves for various samples of grafted triblock copolymer material of the invention and for the functionalized triblock copolymer before grafting of the polyamide, FIG. 7 also containing the curve for a polyamide having been used for the grafting;

FIGS. 4a to 4d are TEM micrographs of the grafted triblock copolymer materials of examples 2, 4 and 5, respectively, and of the material made up of a PMMA_{f} grafted with a polyamide;

FIGS. 6a to 6d are TEM micrographs of the grafted triblock copolymer materials of examples 6, 5, 7 and 8, respectively.

### DETAILED DESCRIPTION

As regards the backbone copolymer of formula B-(A)ₙ, it is in particular a copolymer of which the blocks A have a T_{g} of more than 0° C., in particular more than or equal to 50° C., advantageously more than or equal to 80° C., and the block B has a T_{g} of less than 0° C., in particular less than or equal to −10° C., advantageously less than or equal to −30° C. The monomers making up the blocks A and B can be chosen from vinyl, vinylidene, diene, olefin and alkyl monomers, those skilled in the art knowing how to associate them so as to obtain the desired T_{g} for each of them.

The term “vinyl monomers” is intended to mean acrylic acid or its alkali metal or alkaline-earth metal, such as sodium, potassium or calcium, salts, (meth)acrylates, vinylaromatic monomers, vinyl esters, (meth)acrylonitrile, (meth)acrylamide and mono- and di-(alkyl containing 1 to 18 carbon atoms)-(meth)acrylamides, and monoesters and diesters of maleic anhydride and of maleic acid.

The (meth)acrylates are in particular those of formulae, respectively:

CH₂═C(CH₃)—COOR^{o} and CH₂═CH—COO—R^{o}

in which R^{o} is chosen from the following radicals: linear or branched, primary, secondary or tertiary alkyl containing from 1 to 18 carbon atoms, cycloalkyl containing from 5 to 18 carbon atoms, (alkoxy containing 1 to 18 carbon atoms)-alkyl containing 1 to 18 carbon atoms, (alkylthio containing 1 to 18 carbon atoms)-alkyl containing 1 to 18 carbon atoms, aryl and arylalkyl, these radicals being optionally substituted with at least one halogen atom (such as fluorine) and/or at least one hydroxyl group after protection of this hydroxyl group, the above alkyl groups being linear or branched; and glycidyl, norbornyl or isobornyl (meth)acrylates.

As examples of methacrylates, mention may be made of methyl, ethyl, 2,2,2-trifluoroethyl, n-propyl, isopropyl, n-butyl, sec-butyl, tert-butyl, n-amyl, i-amyl, n-hexyl, 2-ethylhexyl, cyclohexyl, octyl, i-octyl, nonyl, decyl, lauryl, stearyl, phenyl, benzyl, β-hydroxyethyl, isobornyl, hydroxypropyl or hydroxybutyl methacrylates.

As examples of acrylates of the above formula, mention may be made of methyl, ethyl, n-propyl, isopropyl, n-butyl, sec-butyl, tert-butyl, hexyl, 2-ethylhexyl, isooctyl, 3,3,5-trimethylhexyl, nonyl, isodecyl, lauryl, octadecyl, cyclohexyl, phenyl, methoxymethyl, methoxyethyl, ethoxymethyl, ethoxyethyl or perfluorooctyl acrylates.

For the purpose of the present invention, the term “vinylaromatic monomer” is intended to mean an ethylenically unsaturated aromatic monomer such as styrene, vinyltoluene, α-methylstyrene, 4-methylstyrene, 3-methylstyrene, 4-methoxystyrene, 2-hydroxy-methylstyrene, 4-ethylstyrene, 4-ethoxystyrene, 3,4-dimethylstyrene, 2-chlorostyrene, 3-chlorostyrene, 4-chloro-3-methylstyrene, tert-3-butylstyrene, 2,4-dichlorostyrene, 2,6-dichlorostyrene and 1-vinylnaphthalene.

As vinyl esters, mention may be made of vinyl acetate, vinyl propionate, vinyl chloride and vinyl fluoride.

As vinylidene monomer, mention may be made of vinylidene fluoride.

The term “diene monomer” is intended to mean a diene chosen from linear or cyclic, conjugated or nonconjugated dienes, for instance butadiene, 2,3-dimethylbutadiene, isoprene, 1,3-pentadiene, 1,4-pentadiene, 1,4-hexadiene, 1,5-hexadiene, 1,9-decadiene, 5-methylene-2-norbornene, 5-vinyl-2-norbornene, 2-alkyl-2,5-norbornadienes, 5-ethylene-2-norbornene, 5-(2-propenyl-2-norbornene), 5-(5-hexenyl)-2-norbornene, 1,5-cyclooctadiene, bicyclo[2,2,2]octa-2,5-diene, cyclopentadiene, 4,7,8,9-tetrahydroindene and isopropylidene tetrahydroindene.

As olefin monomers, mention may be made of ethylene, butene, hexene and 1-octene. Fluorinated olefin monomers may also be mentioned.

Moreover, n is 1 or is advantageously a natural integer from 2 to 20.

In accordance with one particular embodiment, when n is at least 2, all the blocks A are identical and/or all the blocks A_{g} are identical. Advantageously, p=0.

Mention may most particularly be made of the triblock backbone copolymers A-B-A giving the graft copolymers A_{g}-B-A_{g}.

As regards the blocks A, according to the present invention, they are, in the starting copolymer (before grafting), blocks functionalized so as to allow the grafting.

The preparation of the starting block copolymers is well known to those skilled in the art and will not be repeated herein. In this respect, reference may be made to patent documents WO 2004 087796, WO 2003 062293 and FR 2 807 439. Mention is in particular made of the polymerization process consisting in preparing the block B using a conventional recipe by mixing, with the monomer(s), an alkoxyamine of functionality n, and then in diluting the block B in the mixture of monomers intended to form the block(s) A (controlled radical polymerization).

In particular, the blocks A are functional methacrylic blocks, comprising predominantly methyl methacrylate (MMA) units.

The or each methacrylic block A can thus comprise from 70% to 99.5%, advantageously from 80% to 99.5%, preferably from 85% to 99.5%, by weight, of MMA units.

The or each block A therefore comprises at least one unit carrying at least one function having enabled the grafting and chosen from acid, acid-salt, anhydride or epoxide functions, advantageously from acid and anhydride functions.

The or each unit carrying at least one function chosen from acid, acid-salt, anhydride and epoxide functions is in particular chosen from:
the units derived from at least one monomer comprising a C═C double bond, copolymerizable with the main monomer forming the block A concerned and carrying at least one function chosen from acid, acid-salt, anhydride and epoxide functions; and
the glutaric anhydride units of formula:

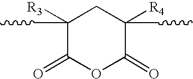

in which R₃ and R₄ denote H or a methyl radical.

In particular, the or each block A comprises at least one glutaric anhydride unit and/or at least one acrylic acid unit and/or at least one methacrylic acid unit.

The or each block A may thus comprise, by weight, from 0.5% to 30%, advantageously from 0.5% to 20%, preferably from 0.5% to 15%, of the unit(s) carrying at least one acid, acid-salt, anhydride or epoxide function, advantageously at least one acid and/or anhydride function.

When said units are derived from a monomer comprising a C═C double bond, copolymerizable with MMA and carrying at least one acid, acid-salt, anhydride or epoxide function, said monomer copolymerizes with MMA via a radical mechanism.

By way of example of a monomer carrying at least one acid function, mention may be made of 2-acrylamido-2-methylpropanesulfonic acid, vinylsulfonic acid, styrenesulfonic acid, 1-allyloxy-2-hydroxypropanesulfonic acid, alkyl allyl sulfosuccinic acid, acrylic acid, methacrylic acid, crotonic acid, itaconic acid, fumaric acid and maleic acid.

Preferably, said monomer is acrylic acid or methacrylic acid since these two monomers copolymerize very well with MMA. Methacrylic acid is most particularly preferred. This is because, when the copolymerization is carried out in an aqueous dispersed medium, acrylic acid remains to a large extent solubilized in the water, which is not the case with methacrylic acid. The groups carrying an acid function are then the following:

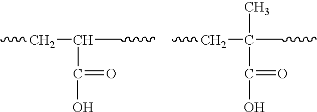

The acid-salt function can be obtained from an acid function by known techniques. A monomer carrying at least one acid-salt function is therefore derived from a monomer carrying at least one acid function by means of a neutralization reaction. A monomer carrying at least one acid-salt function is derived from a monomer carrying at least one acid function of the above list. The cation of the acid salt may, for example, be Li⁺, Na⁺, K⁺ or a quaternary ammonium salt.

By way of example of a monomer carrying at least one anhydride function, mention may be made of maleic anhydride, itaconic anhydride or citraconic anhydride.

By way of example of a monomer carrying at least one epoxide function, mention may be made of aliphatic glycidyl esters or aliphatic glycidyl ethers, such as allyl glycidyl ether, vinyl glycidyl ether, glycidyl maleate and glycidyl itaconate, glycidyl acrylate and glycidyl methacrylate, alicyclic glycidyl esters or alicyclic glycidyl ethers, such as 2-cyclohexene-1-glycidyl ether, cyclohexene-4,5-diglycidyl carboxylate, cyclohexene-4-glycidyl carboxylate, 5-norbornene-2-methyl-2-glycidyl carboxylate and endo-cis-bicyclo(2,2,1)-5-heptene-2,3-diglycidyl dicarboxylate. Glycidyl methacrylate is a preferred monomer since, like MMA, it is a methacrylic ester and, consequently, it copolymerizes efficiently with MMA.

Moreover, the or each block A may also comprise at least one unit of a comonomer (a) having at least one C═C double bond, copolymerizable with the main monomer forming said block and which does not carry an acid, acid-salt, anhydride or epoxide function.

The comonomer (a) may be chosen, for example, from the following monomers:
the acrylic monomers of formula CH₂═CH—C(═O)—O—R₁ where R₁ denotes a linear, cyclic or branched C₁-C₄₀ alkyl group optionally substituted with a halogen atom or a hydroxyl, alkoxy or cyano group, such as, for example, methyl, ethyl, propyl, n-butyl, isobutyl, tert-butyl or 2-ethylhexyl acrylate, hydroxyalkyl acrylates, acrylonitrile;
the methacrylic monomers of formula CH₂═C(CH₃)—C(═O)—O—R₂ where R₂ denotes a linear, cyclic or branched C₂-C₄₀ alkyl group optionally substituted with a halogen atom or a hydroxyl, alkoxy, cyano, amino or epoxy group, such as, for example, ethyl, propyl, n-butyl, isobutyl, tert-butyl or 2-ethylhexyl methacrylate, hydroxyalkyl methacrylates, methacrylonitrile; and
vinylaromatic monomers such as, for example, styrene, substituted styrenes, for instance alpha-methylstyrene, monochlorostyrene, tert-butylstyrene.

Advantageously, the comonomer (a) contains only one C═C double bond. Preferably, the comonomer (a) is an acrylic monomer CH₂═CH—C(═O)—O—R₁ in which R₁ is a C₁-C₈ alkyl, such as, for example, methyl, ethyl, propyl, butyl or 2-ethylhexyl acrylate, or else a methacrylic monomer CH₂═C(CH₃)—C(═O)—O—R₂ in which R₂ is a C₂-C₈ alkyl, such as ethyl, propyl, butyl or 2-ethylhexyl methacrylate.

The or each block A may be MMA-based and comprise, by weight:
from 70% to 99.5% of MMA;
from 0 to 20% of a comonomer (a) having at least one C═C double bond, copolymerizable with MMA and which does not carry an acid, acid-salt, anhydride or epoxide function;
from 0.5% to 30% of at least one group carrying at least one acid, acid-salt, anhydride or epoxide function.

In particular, the or each block A may be MMA-based and comprise, by weight:
from 80% to 99.5% of MMA;
from 0 to 10% of a comonomer (a) having at least one C═C double bond, copolymerizable with MMA and which does not carry an acid, acid-salt, anhydride or epoxide function;
from 0.5% to 20% of at least one group carrying at least one acid, acid-salt, anhydride or epoxide function.

More particularly, the or each MMA-based block A may comprise, by weight:
from 85% to 99.5% of MMA;
from 0 to 5% of a comonomer (a) having at least one C═C double bond, copolymerizable with MMA and which does not carry an acid, acid-salt, anhydride or epoxide function; and
from 0.5% to 15% of at least one group carrying at least one acid, acid-salt, anhydride or epoxide function.

A methacrylic functional block A is generally obtained by copolymerization of MMA with at least one monomer carrying at least one acid, acid-salt, anhydride or epoxide function, optionally in the presence of a comonomer A having at least one C═C double bond, copolymerizable with MMA and which does not carry an acid, anhydride or epoxide function. The copolymerization may be carried out in bulk, in solution in a solvent, or else in a dispersed medium (suspension, emulsion, miniemulsion).

A methacrylic functional block A may also comprise glutaric anhydride groups represented by the formula:

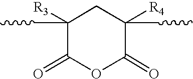

in which R₃ and R₄ denote H or a methyl radical. Said groups are obtained through an intramolecular reaction between two functions side by side, for example between two acid functions, between an acid function and an ester function or between two ester functions. Groups of this type are particularly appreciated owing to their high reactivity with respect to the primary amine functions of polyamide.

When a methacrylic functional block A comprising glutaric anhydride groups is prepared from acrylic or methacrylic acid, the conversion of the acid functions into glutaric anhydride functions is often incomplete. The methacrylic functional block therefore comprises both glutaric anhydride groups and acrylic or methacrylic acid groups (which have not reacted to give glutaric anhydride functions). This type of methacrylic functional block is most particularly preferred since the glutaric anhydride groups are highly reactive, especially with the primary amine functions. Furthermore, the glutaric anhydride groups are introduced more readily into the methacrylic functional block than by direct copolymerization of MMA with maleic anhydride or with another monomer carrying an anhydride group.

The relative proportion of acid functions and of glutaric anhydride functions depends on the content of initial acid functions and on the dehydration conditions (temperature, reaction time, pressure, presence or absence of a catalyst, etc.). The overall content of acid functions and of glutaric anhydride functions is between 0.5% and 30%, advantageously between 0.5% and 20%, preferably between 0.5% and 15%. The relative proportion (by weight) of glutaric anhydride functions relative to the glutaric anhydride functions and acid functions (i.e. the percentage by weight of glutaric anhydride functions/(glutaric anhydride functions+acid functions)) is, for its part, between 1% and 100%, preferably between 10% and 90%, more preferably from 50% to 90%.

In order to obtain a methacrylic functional block carrying glutaric anhydride groups, use may be made of one of the methods described in documents EP 0318197 B1, Japanese Kokai 60/231756, Japanese Kokai 61/254608 or Japanese Kokai 61/43604, GB 1437176, U.S. Pat. No. 4,789,709. The reaction for obtaining the glutaric anhydride groups is carried out at a temperature of more than 150° C., preferably between 200 and 280° C., optionally in the presence of a reduced pressure of less than 1 bar and optionally in the presence of an acidic or basic catalyst. It may be carried out in an extruder equipped with a venting well or else in a devolatilizer. A secondary amine may be used in a manner similar to that which is described in EP 0 318 197.

As regards the block B, according to the invention, it advantageously comprises butyl acrylate units or predominantly butyl acrylate units.

The weight-average molecular mass (M_{w}) of the functional copolymer B-(A)ₙ is generally between 10 000 and 500 000 g/mol. Preferably, M_{w} is between 50 000 and 200 000 g/mol since, on the one hand, there is a risk that very low masses will affect the glass transition temperature (T_{g}) of the polymer, whereas very high masses affect its fluidity and make its melt-conversion difficult. Those skilled in the art know how to adjust the weight-average molecular mass, for example by introducing a transfer agent and/or using the polymerization temperature parameter.

As regards the polyamide, it may be a homopolyamide or a copolyamide terminated with a primary amine function or an acid function. Preferably, it is a primary amine function, which exhibits good reactivity with respect to acid, acid-salt, anhydride or epoxide functions. The primary amine function is highly reactive with respect to acid or anhydride functions.

Advantageously, in order to provide the material according to the invention with thermomechanical resistance, the polyamide has a melting point of between 100 and 300° C., preferably between 140 and 250° C.

The term “homopolyamide” is intended to mean the products of condensation of a lactam (or of the corresponding amino acid) or of a diacid with a diamine (or their salts). The chain limiter, which may be a diacid, a monoacid, a diamine or a monoamine in the case of lactams and another diacid or another diamine in the case of polyamides resulting from the condensation of a diamine with a diacid, is not taken into account. The term “copolyamide” is intended to mean the above in which there is at least one monomer more than necessary, for example two lactams or one diamine and two acids or else one diamine, one diacid and one lactam.

The polyamide is chosen from PA 6, PA 6-6, PA 11, PA 12 and copolymers thereof. Preferably, it is PA 6 since this polyamide provides good solvent-resistance by virtue of its crystallinity and also good thermomechanical resistance.

According to a first type, the copolyamide results from the condensation of at least two alpha,omega-aminocarboxylic acids or of at least two lactams containing from 6 to 12 carbon atoms or of a lactam and of an aminocarboxylic acid not having the same number of carbon atoms. The copolyamide of this first type may also comprise units which are residues of diamines and of dicarboxylic acids.

By way of example of a dicarboxylic acid, mention may be made of diacids such as isophthalic acid, terephthalic acid, adipic acid, azelaic acid, suberic acid, sebacic acid, nonanedioic acid and dodecanedioic acid.

By way of example of a diamine, mention may be made of hexamethylenediamine, dodecamethylenediamine, meta-xylylenediamine, bis-p-aminocyclohexylmethane and trimethylhexamethylenediamine.

By way of example of an alpha,omega-aminocarboxylic acid, mention may be made of aminocaproic acid, aminoundecanoic acid and aminododecanoic acid.

By way of example of a lactam, mention may be made of caprolactam, oenantholactam and laurolactam.

According to a second type, the copolyamide results from the condensation of at least one alpha,omega-aminocarboxylic acid (or a lactam), at least one diamine and at least one dicarboxylic acid. The alpha,omega-aminocarboxylic acid, the lactam and the dicarboxylic acid may be chosen from those mentioned above. The diamine may be a branched, linear or cyclic, or alternatively an aryl, aliphatic diamine. By way of examples, mention may be made of hexamethylenediamine, piperazine, isophorone diamine (IPD), methylpentamethylenediamine (MPDM), bis(aminocyclohexyl)methane (BACM) or bis(3-methyl-4-aminocyclohexyl)methane (BMACM).

In order for the polyamide to be terminated with a primary amine function, use may be made of a chain limiter of formula:

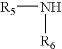

in which R₅ is hydrogen or a linear or branched alkyl group containing up to 20 carbon atoms, R₆ is a linear or branched alkyl or alkenyl group containing up to 20 carbon atoms; a limiting cycloaliphatic radical may, for example, be laurylamine or oleylamine.

The polyamide terminated with a primary amine or acid function has a number-average molecular mass (Mₙ) of between 1000 and 50 000 g/mol, rather of between 1000 and 40 000 g/mol, advantageously of between 1000 and 30 000 g/mol, preferably of between 1000 and 20 000 g/mol. This average molecular mass is determined by size exclusion chromatography calibrated using PMMA samples. Mₙ is therefore given in PMMA equivalents.

The preferred monofunctional polymerization limiters are laurylamine and oleylamine. The polyamides may be produced according to processes known to those skilled in the art, for example by autoclave polycondensation. The polycondensation is carried out at a temperature of in general between 200 and 300° C., under vacuum or under an inert atmosphere, with stirring of the reaction mixture. The average chain length of the polyamide is determined by the initial molar ratio between the polycondensable monomer or the lactam and the chain limiter. To calculate the average chain length, one usually allows one molecule of chain limiter per oligomer chain.

### Graft Copolymer:

The graft copolymer according to the invention may in particular comprise the following characteristics:
the number-average molecular mass of a or of each block A is between 5000 and 100 000 g/mol, rather between 10 000 and 70 000 g/mol, advantageously between 15 000 and 50 000 g/mol;
the number-average molecular mass of the block B is between 5000 and 100 000 g/mol, rather between 5000 and 60 000 g/mol, advantageously between 5000 and 40 000 g/mol, preferably between 10 000 and 40 000 g/mol; and
the number-average molecular mass of the polyamide grafts is between 1000 and 50 000 g/mol, rather between 1000 and 40 000 g/mol, advantageously between 1000 and 30 000 g/mol, preferably between 1000 and 20 000 g/mol.

The ratio by mass of the copolymer B-(A)ₙ as defined above to the polyamide (PA) grafts is in particular from 10:90 to 95:5, advantageously from 50:50 to 90:10, preferably from 60:40 to 80:20.

The graft copolymer according to the invention is obtained by reacting the copolymer B-(A)ₙ (with the block(s) A functionalized) and the polyamide terminated with a primary-amine or acid function. If the polyamide is terminated with a primary amine function, the blocks A preferably carry acid, acid-salt, anhydride or epoxide functions. If the polyamide is terminated with an acid function, the blocks A preferably carry epoxide functions.

During the reaction of the copolymer and of the polyamide terminated with a primary-amine or acid function, a graft copolymer forms, composed of a backbone and of polyamide grafts (for further details on graft copolymers, reference may be made to Kirk-Othmer, Encyclopedia of Chemical Technology, 3^{rd} Edition, Volume 6, page 798). Depending on the nature of the methacrylic functional blocks preferentially forming the blocks A, on the amounts of functional PMMA and of polyamide that are introduced and also on the reaction conditions, a graft copolymer more or less rich in grafts can be obtained.

On average, there are, in general, from 1 to 100, preferably from 1 to 50, polyamide (PA) grafts per block A_{g}.

The reaction may be carried out in solution in a solvent or else in the molten state. Preferably, the reaction is carried out in the molten state since this makes it possible to avoid the use of solvent that must subsequently be removed once the reaction is complete. The molten state may also accelerate the reaction rate. Any mixing tool suitable for thermoplastics may be used. A twin-screw, in particular co-rotating twin-screw, extruder is entirely suitable since it makes it possible to carry out the mixing in the molten state, can operate continuously and provide good homogenization of the starting copolymer and of the polyamide. The reaction is carried out at a temperature of between 180 and 320° C., preferably between 180 and 280° C. The average residence time of the molten material in the extruder may be between 1 second and 15 minutes, rather between 1 second and 10 minutes. If an extruder is used, granules are recovered at the extruder output. These granules can subsequently be put into the desired form (film, injected part, molded part, sheet, etc.) using a tool for transforming thermoplastics, known to those skilled in the art, for example an extruder.

For the reaction, from 5% to 90%, rather from 10% to 50%, advantageously from 20% to 40% of polyamide terminated with a primary-amine or acid function are used for, respectively, from 10% to 95%, rather from 50% to 90%, advantageously from 60% to 80% of starting copolymer. The reaction of 20% to 40% of polyamide terminated with a primary-amine or acid function and of 60% to 80% of starting copolymer makes it possible to obtain a material which has good transparency, A being MMA-based.

Depending on the initial amounts of copolymer B-(A)ₙ and of polyamide, and also on the reaction conditions (for example, contact time, temperature), starting copolymer and/or polyamide which has not reacted may remain. The reaction therefore results in a material composed:
of the graft copolymer of the invention;
of copolymer B-(A)ₙ which has not reacted, the block(s) A carrying functionalities capable of reacting with primary-amine or acid functions;
of polyamide terminated with a primary-amine or acid function which has not reacted.

More specifically, the material is composed, by weight:
of 10% to 98% of graft copolymer of the invention;
of 1% to 50% of said (functional) copolymer B-(A)ₙ which has not reacted;
of 1% to 50% of polyamide terminated with a primary-amine or acid function which has not reacted;
   the total coming to 100%.

Preferably, the material is composed, by weight:
of 20% to 80% of graft copolymer of the invention;
of 5% to 50% of said (functional) copolymer B-(A)ₙ which has not reacted;
of 5% to 50% of polyamide terminated with a primary-amine or acid function which has not reacted;
   the total coming to 100%.

The presence of starting copolymer and/or of the polyamide which has (have) not reacted is not necessarily harmful to the final properties of the material, it may even improve some of its properties. The starting copolymer which has not reacted has a strong affinity with the backbone of the graft copolymer, the polyamide which has not reacted has a strong affinity with the grafts of the graft copolymer. A phenomenon of swelling of the backbone and of the grafts of the graft copolymer may therefore be observed, said phenomenon having already been noted for other types of graft copolymers (in this respect, see the following article: H. Pernot et al., Nature Mater. 2002, Vol. 1, page 54).

The Applicant has noted that, in the case in particular where A is MMA-based, the graft copolymer, like the starting functionalized copolymer, becomes organized in nanodomains, i.e. in domains of which the average size is less than 100 nm. This organization makes it possible to obtain a homogeneous material having all the properties described above.

### Impact Additives:

An impact modifier of core-shell type may be added to the material for the purpose of improving its impact strength. This impact modifier is in the form of fine particles having an elastomer core and at least one thermoplastic shell, the size of the particles being in general less than 1 μm and advantageously between 50 and 300 nm. The impact modifier is prepared by means of emulsion polymerization. From 0 to 60%, preferably from 0 to 30% by weight, of impact modifier of core-shell type, relative to the material, is added to the material.

The core may be composed, for example:
of a homopolymer of isoprene or of butadiene or
of copolymers of isoprene with at most 30 mol % of a vinyl monomer or
of copolymers of butadiene with at most 30 mol % of a vinyl monomer.

The vinyl monomer may be styrene, an alkylstyrene, acrylonitrile or an alkyl (meth)acrylate.

The core may also be composed:
of a homopolymer of an alkyl (meth)acrylate or
of copolymers of an alkyl (meth)acrylate with at most 30 mol % of a monomer chosen from another alkyl (meth)acrylate and a vinyl monomer.

The alkyl (meth)acrylate is advantageously butyl acrylate. The vinyl monomer may be styrene, an alkyl-styrene, acrylonitrile, butadiene or isoprene.

The core may advantageously be totally or partially crosslinked. It is sufficient to add monomers which are at least difunctional during the preparation of the core; these monomers may be chosen from poly(meth)acrylic esters of polyols, such as butylene di(meth)acrylate and trimethylolpropane trimethacrylate. Other difunctional monomers are, for example, divinylbenzene, trivinylbenzene, vinyl acrylate and vinyl methacrylate. The core may also be crosslinked by introducing therein, by grafting or as a comonomer during the polymerization, unsaturated functional monomers such as unsaturated carboxylic acid anhydrides, unsaturated carboxylic acids and unsaturated epoxides. By way of example, mention may be made of maleic anhydride, (meth)acrylic acid and glycidyl methacrylate.

The shell(s) is (are) composed of a homopolymer of styrene, of an alkylstyrene or of methyl methacrylate or of copolymers comprising at least 70 mol % of one of these monomers above and at least one comonomer chosen from the other monomers above, another alkyl (meth)acrylate, vinyl acetate and acrylonitrile. The shell may be functionalized by introducing therein, by grafting or as a comonomer during the polymerization, unsaturated functional monomers such as unsaturated carboxylic acid anhydrides, unsaturated carboxylic acids and unsaturated epoxides. By way of example, mention may be made of maleic anhydride, (meth)acrylic acid and glycidyl methacrylate.

By way of example of an impact modifier, mention may be made of core-shell copolymers having a polystyrene shell and core-shell copolymers having a PMMA shell. There are also core-shell copolymers having two shells, one of polystyrene and the other, on the outside, of PMMA. Examples of impact modifiers, and also the method for the preparation thereof, are described in the following patents: U.S. Pat. No. 4,180,494, U.S. Pat. No. 3,808,180, U.S. Pat. No. 4,096,202, U.S. Pat. No. 4,260,693, U.S. Pat. No. 3,287,443, U.S. Pat. No. 3,657,391, U.S. Pat. No. 4,299,928, U.S. Pat. No. 3,985,704, U.S. Pat. No. 5,773,520.

Advantageously, the core represents, by weight, 70% to 90% of the impact modifier and the shell from 30% to 10%.

The impact modifier may be of the soft/hard type. By way of example of an impact modifier of the soft/hard type, mention may be made of that composed:
(i) of 75 to 80 parts of a core comprising, by moles, at least 93% of butadiene, 5% of styrene and 0.5% to 1% of divinylbenzene, and
(ii) of 25 to 20 parts of two shells essentially of the same weight, one on the inside made of polystyrene and the other on the outside made of PMMA.

As another example of an impact modifier of soft/hard type, mention may be made of that having a poly(butyl acrylate) or butyl acrylate/butadiene copolymer core and a PMMA shell.

The impact modifier may also be of the hard/soft/hard type, i.e. it contains, in the following order, a hard core, a soft shell and a hard shell. The hard parts may be composed of the polymers of the shell of the above soft/hard modifiers and the soft part may be composed of the polymers of the core of the soft/hard modifiers.

As an example of an impact modifier of hard/soft/hard type, mention may be made of that composed:

(i) of a core made of a methyl methacrylate/ethyl acrylate copolymer,
(ii) of a layer made of a butyl acrylate/styrene copolymer,
(iii) of a shell made of a methyl methacrylate/ethyl acrylate copolymer.

The impact modifier may also be of the hard (core)/soft/semi-hard type. In this case, the “semi-hard” outer shell is composed of two shells: one the intermediate shell and the other the outer shell. The intermediate shell is a copolymer of methyl methacrylate, of styrene and of at least one monomer chosen from alkyl acrylates, butadiene and isoprene. The outer shell is a PMMA homopolymer or copolymer.

One example of a hard/soft/semi-hard impact modifier is that composed, in this order:

(i) of a core made of a methyl methacrylate/ethyl acrylate copolymer,
(ii) of a shell made of a butyl acrylate/styrene copolymer,
(iii) of a shell made of a methyl methacrylate/butyl acrylate/styrene copolymer, and
(iv) of a shell made of a methyl methacrylate/ethyl acrylate copolymer.

The impact modifier and the material according to the invention are mixed using a mixing tool suitable for thermoplastics, for example an extruder.

### Other Additives:

Other additives may also be added to the material. They may be anti-UV additive(s), antioxidant(s), demolding agent(s), lubricant(s), etc. By way of example of anti-UV additives, mention may be made of those described in U.S. Pat. No. 5,256,472. Benzotriazoles and benzophenones are advantageously used. By way of example, use may be made of Tinuvin® 213 or Tinuvin® 109, and preferably Tinuvin® 234 or Tinuvin P® or Tinuvin 770® from the company Ciba Speciality Chemicals.

### Uses of the Graft Copolymer and of the Material Containing it:

The graft copolymer and the material containing it according to the invention can be used in the form of films, of extruded blow-molded parts or injected parts. It may also be in the form of extruded sheets which are used for sanitary applications (manufacture of bathtubs, washbasins, shower trays, etc.). In the sanitary field, the chemical resistance and the cracking strength of the material are two highly-rated properties.

The graft copolymer and the material containing it according to the invention may also be transformed into organic windowpanes, window frames, pipes, ventilation shafts, seals, etc. In the transport field, for example, it may be used to manufacture decorative panels in automobiles, trucks, trains and airplanes. In the field of sport, it may be used as injected parts in sports shoes, in golf clubs, etc. It may also find uses in fibers, for example as coatings for optical fibers, but also in parts for medical uses, in the field of electrical and electronic applications, and more generally as technical polymers, without excluding uses in packaging.

The graft copolymer and the material containing it according to the invention may also be used as a compatibilizing agent for obtaining an alloy based on a polyamide and on a polymer chosen from PMMA, PVDF, PVC and acrylic polymers. A co-rotating extruder may, for example, be used to perform the mixing. Preferably, the polymer of the alloy is PMMA or PVDF.

The polyamide may be a PA 6, PA 6-6, PA 11 or PA 12. The polyamide of the alloy is of the same nature as the polyamide terminated with a primary-amine or acid function which is used to obtain the grafts. Thus, for example, for compatibilizing a polyamide 12 with PMMA, the grafts are made of polyamide 12.

PMMA denotes a homo- or copolymer of MMA comprising more than 50% by weight of MMA. When the PMMA is a copolymer, the MMA is copolymerized with at least one comonomer chosen from:
acrylic monomers of formula CH₂═CH—C(═O)—O—R₁ where R₁ denotes a linear, cyclic or branched C₁-C₄₀ alkyl group optionally substituted with a halogen atom or a hydroxyl, alkoxy or cyano group, such as, for example, methyl, ethyl, propyl, n-butyl, isobutyl, tert-butyl or 2-ethylhexyl acrylate, hydroxyalkyl acrylates, acrylonitrile;
methacrylic monomers of formula CH₂═C(CH₃)—C(═O)—O—R₂ where R₂ denotes a linear, cyclic or branched C₂-C₄₀ alkyl group optionally substituted with a halogen atom or a hydroxyl, alkoxy, cyano, amino or epoxy group, such as, for example, ethyl, propyl, n-butyl, isobutyl, tert-butyl or 2-ethylhexyl methacrylate, hydroxyalkyl methacrylates, methacrylonitrile;
vinylaromatic monomers such as, for example, styrene, or substituted styrenes such as alpha-methylstyrene, monochlorostyrene or tert-butylstyrene.

PVDF denotes a homo- or copolymer of vinylidene fluoride (VF₂) comprising more than 50% by weight of VF₂. When the PVDF is a copolymer, the VF₂ is copolymerized with at least one comonomer chosen from compounds containing a vinyl group capable of opening up so as to polymerize and which contains, directly attached to this vinyl group, at least one fluorine atom, one fluoroalkyl group or one fluoroalkoxy group. By way of example of a comonomer, mention may be made of vinyl fluoride; trifluoroethylene; chlorotrifluoroethylene (CTFE); 1,2-difluoroethylene; tetrafluoroethylene (TFE); hexafluoropropylene (HFP); perfluoro(alkyl vinyl)ethers such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is equal to 1, 2, 3, 4 or 5; the product of formula R₇CH₂OCF═CF₂ in which R₇ is hydrogen or F(CF₂)_{z} and z is 1, 2, 3 or 4; the product of formula R₈OCF═CH₂ in which R₈ is F(CF₂)_{z}— and z is 1, 2, 3 or 4; perfluorobutylethylene (PFBE); 3,3,3-trifluoropropene and 2-trifluoromethyl-3,3,3-trifluoro-1-propene.

The alloy comprises:
from 2% to 20% of the graft copolymer or of the material containing it according to the invention;
from 10% to 90% of a polyamide that may be chosen from PA 6, PA 6-6, PA 11 or PA 12;
from 10% to 90% of a polymer chosen from PMMA, PVDF, PVC and acrylic polymers.

The graft copolymer or the material containing it, according to the invention, may also serve as a coextrusion binder in a multilayer structure based on polyamide and on a polymer chosen from PMMA, PVDF, PVC and acrylic polymers. The multilayer structure is therefore composed, in the following order, of the following layers:
a layer c1 of polyamide;
a layer c2 of the material according to the invention;
a layer c3 of a polymer chosen from PMMA, PVDF, PVC and acrylic polymers; the layers adhering to one another.

The definitions of the terms polyamide, PMMA and PVDF were given above.

The multilayer structure may, for example, be in the form of a film, a sheet, a tube or a hollow body. In the case of a multilayer structure in the form of a film, each layer c1, c2 and c3 may have a thickness of between 2 and 300 μm, advantageously between 5 and 200 μm, preferably between 10 and 100 μm, In the case of a multilayer structure in the form of a sheet, a tube or a hollow body, the layer c2 of the material according to the invention has a thickness of between 2 and 300 μm, preferably between 2 and 100 μm. The other layers c1 and c3 have a thickness of greater than 100 μm, rather between 0.1 and 100 mm.

### EXAMPLES

The following examples illustrate the invention without, however, limiting the scope thereof.

In these examples, the following abbreviations have been used:
MMA: methyl methacrylate;
BA: butyl acrylate;
MAA: methacrylic acid;
THF: tetrahydrofuran;
PTA phosphotungstic acid;
BzOH: benzyl alcohol;
CDCl₃: deuterated chloroform;
PA: polyamide;
PMMA_{f}: block of a copolymer of MMA and of MAA containing dimethylglutaric anhydride groups;
P(MMA_{f}-b-BA-b-MMA_{f}): triblock copolymer in which the end blocks are PMMA_{f} blocks and the central block is a poly(butyl acrylate) block, the methacrylic acid and dimethylglutaric anhydride groups constituting reactive sites;
P(MMA_{f}-b-BA-b-MMA_{f})-g-PA: triblock graft copolymers of the invention;
R: ratio by mass P(MMA_{f}-b-BA-b-MMA_{f}):PA of the two polymers (backbone and grafts) used in the examples illustrating the present invention;
SEC: size exclusion chromatography;
FTIR: Fourier transform infrared spectroscopy;
TEM: transmission electron microscopy;
¹H NMR: proton nuclear magnetic resonance;
DSC: differential scanning calorimetry;
DMA: dynamic mechanical analysis;
Mn: number-average molecular mass;
Iₚ: polydispersity index (ratio of the weight-average molar mass to the number-average molar mass);
Mp: melting point.

### General Conditions for Preparing the Graft Triblock Copolymer Materials of the Invention

The graft triblock copolymer materials were prepared by reactive extrusion of P(MMA_{f}-b-BA-b-MMA_{f}) and of a PA comprising a terminal primary amine function, on a DACA microextruder with a capacity of 3 g, at 250° C. for 6 minutes at a rotation speed of 200 rpm under a nitrogen atmosphere.

In order to observe the stability of the materials, the samples were subjected to a thermal annealing at 235° C. for 1 hour under vacuum.

P(MMA_{f}-b-BA-b-MMA_{f})

The characteristics of the P(MMA_{f}-b-BA-b-MMA_{f}) copolymer are the following:
the Mn and the Iₚ, determined by SEC with PMMA as standard, are respectively 70 000 g/mol and 2.1;
the molar percentage of BA is 34%, evaluated by ¹H NMR;
the molar percentages of MMA, MAA and dimethylglutaric anhydride are respectively 58%, 6% and 2%, evaluated by FTIR in solution in chloroform.

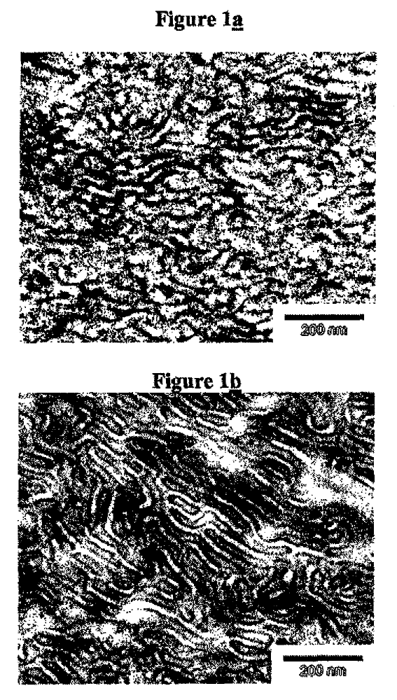

The morphology of the P(MMA_{f}-b-BA-b-MMA_{f}) copolymer was studied by TEM; two complementary labelings were tested, i.e.:
liquid-phase ruthenium labeling, which makes it possible to increase the density of the butyl acrylate, which appears black on FIG. 1a; and
PTA labeling in aqueous solution with BzOH as labeling promoter, which makes it possible to label the PMMA (in gray on FIG. 1b).

The P(MMA_{f}-b-BA-b-MMA_{f}) copolymer exhibits an undulated and interconnected lamellar morphology with no long-distance order, which can be described as a labyrinth-like lamellar phase.

### PA Comprising a Terminal Primary Amine Function

Various PAs comprising a terminal primary amine function were used. These polyamides were characterized by their Mn determined by ¹H NMR in CDCl₃ with trifluoroacetic anhydride, and their Mp, measured by DSC.
PA1: It is a monoaminated PA6 with an Mn of 2550 g/mol, having an Mp of 218° C.
PA2: It is a monoaminated PA6 with an Mn of 5320 g/mol, having an Mp of 219° C.
PA3: It is a monoaminated PA6 with an Mn of 16 500 g/mol, having an Mp of 222° C.

### Characterizations of the Graft Triblock Copolymer Materials of the Invention:

### Thermomechanical Resistance:

The thermomechanical behavior of the samples obtained was monitored by DMA. The rods were pressed at 250° C. in the form of rectangular bars, and then subjected to a deformation in flexure of 20 microns in amplitude at a frequency of 1 Hz, between −80 and 250° C. with a ramp of 3° C./min.

The storage modulus (E′) is measured using the TA Instruments DMA 9980 machine. The storage moduli obtained are given in MPa units.

### Chemical Resistance:

The test consists in observing the resistance of a rod placed in chloroform for three days at ambient temperature (the rod represents 3% by weight relative to the chloroform). The assessment of the resistance is qualitative and consists in determining whether the rod keeps its shape or disintegrates on contact with the solvent. If the rod disintegrates, the chemical resistance is very poor, whereas if the rod keeps its shape, the chemical resistance is very good.

### Transparency:

The transparency is assessed qualitatively.

### Analysis Under a Microscope:

The morphology was studied by TEM on leaving an extruder or after annealing (1 hour at 235° C. under vacuum). The samples were microtomed at ambient temperature and then labeled:
either with ruthenium: the domains formed by the poly(butyl acrylate) blocks, the poly(methyl methacrylate) blocks and the polyamide grafts appear, respectively, in black, white and gray;
or with PTA in the presence of BzOH: the domains formed by the polyamide (free or in the form of grafts), and the poly(methyl methacrylate) and poly(butyl acrylate) blocks appear, respectively, in black, gray and white.

### Examples 1 to 3

### Preparation of P(MMA_{f}-b-BA-b-MAA_{f}): PA1 Copolymer Materials by Reactive Extrusion

The graft triblock copolymers of the title were prepared with a ratio R of, respectively, 80:20 (example 1); 70:30 (example 2) and 60:40 (example 3) under the conditions indicated above.

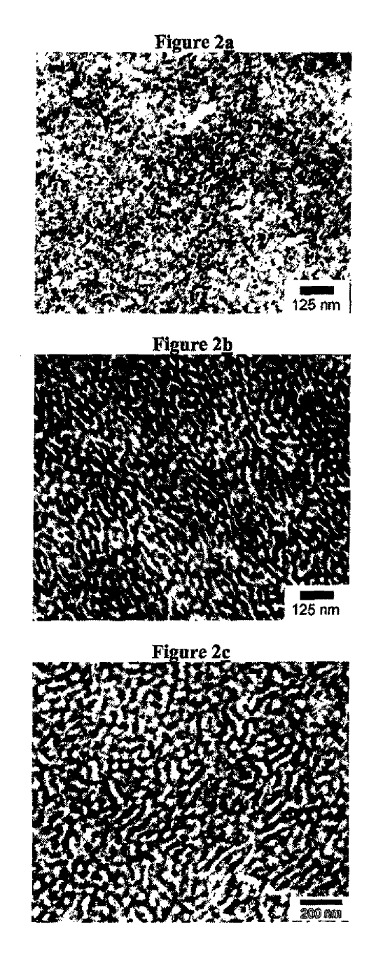

FIGS. 2a and 2b show the morphology of the material of example 2 on leaving an extruder, observed by TEM: ruthenium labeling (FIG. 2a) and PTA/BzOH labeling (FIG. 2h).

The same material annealed for 1 hour did not change, as can be seen in FIG. 2c (PTA/BzOH labeling).

The graft material is therefore stable and the residual homopolymers are incorporated into the structure of the graft copolymer.

The morphologies of the materials of examples 1 and 3 were also very fine and stable with respect to annealing.

In order to verify the stability of the materials, the rods of the extrudates annealed at 235° C. under vacuum for 1 hour could be dissolved in benzyl alcohol at 130° C., thereby showing that the P(MMA_{f}-b-BA-b-MMA_{f}) had not undergone irreversible crosslinking.

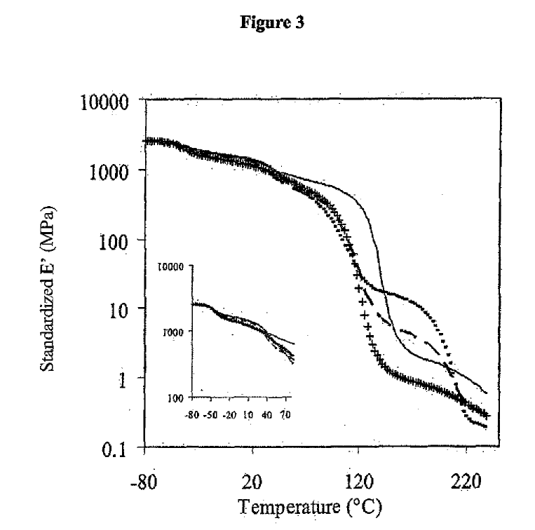

FIG. 3 represents the storage modulus curves obtained by DMA for the samples of examples 1 to 3 and for a sample of P(MMA_{f}-b-BA-b-MMA_{f}) as a function of temperature:
P(MMA_{f}-b-BA-b-MMA_{f}): solid line
graft copolymer material of example 1: ++++++++++++
graft copolymer material of example 2: dotted line
graft copolymer material of example 3: succession of “−” signs.

In table 1 hereinafter, the value of the storage modulus at 20° C. has been given.

In FIG. 3, all the transitions of the components of the blend can be observed:
glass transition of the poly(butyl acrylate) at −50° C.;
glass transition of the polyamide at approximately 30° C.; and
glass transition of the poly(methyl methacrylate) at around 130° C.; and finally, the melting of the crystalline part of PA6 at 220° C.

In the systems of examples 1 to 3, the modulus at ambient temperature (20° C.) is slightly higher than the reference.

A modulus plateau appears above the transition temperature of the poly(methyl methacrylate) block starting from 30% of PA-1 in the material. The plateau results from the crystallinity of the PA-1 in the blends. The grafting has therefore indeed taken place.

### Examples 4 and 5

### Preparation of P(MMA_{f}-b-BA-b-MMA_{f}): PA2 and PA3 Copolymers by Reactive Extrusion

The copolymers of the title, grafted with PA2 (example 4) and PA3 (example 5), in a ratio R=70:30, were prepared under the conditions indicated above.

It was observed that the increase in the size of the graft does not significantly damage the transparency of the samples, whereas a rod of PMMA_{f}/PA3 with R=70:30, prepared under the same conditions, is white.

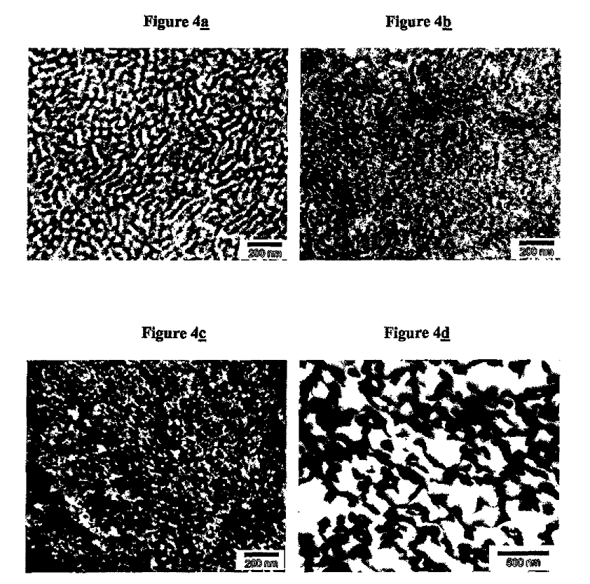

The morphology of the materials of examples 2, 4 and 5 and of said PMMA_{f}/PA3 is also illustrated by FIGS. 4a, 4b, 4c and 4d, respectively, where the micrographs of the various samples are shown, observed by TEM after annealing for 1 hour at 235° C. under vacuum and labeling with PTA (the domain formed by the polyamide appears in black).

It can be seen that, when the size of the graft increases in the P(MMA_{f}-b-BA-b-MMA_{f})/PA systems, the dispersion remains very fine and homogeneous. This result is very different than that obtained in the absence of the central block of poly(butyl acrylate) and suggests that the latter plays an essential role with respect to the grafting reaction. In all the systems, there is graft copolymer and the possible residual polymers P(MMA_{f}-b-BA-b-MMA_{f}) and PA are very well incorporated into the structure.

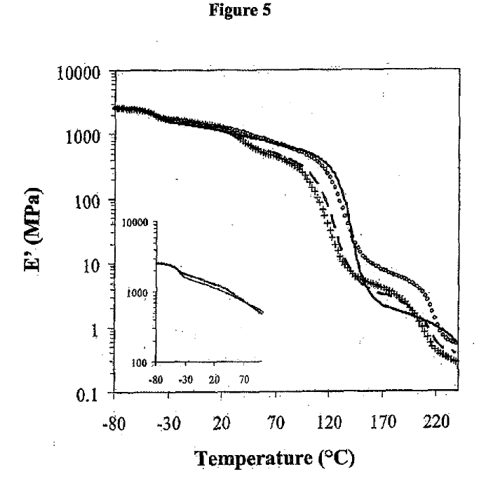

The curves of change in storage modulus as a function of temperature, obtained by DMA, are given in FIG. 5 for the samples of examples 2, 4 and 5 and for a sample of P(MMA_{f}-b-BA-b-MMA_{f}):
P(MMA_{f}-b-BA-b-MMA_{f}): solid line
graft copolymer of example 2: dotted line
graft copolymer of example 4: ++++++++++++
graft copolymer of example 5: oooooooooooo

In table 1 hereinafter, the storage modulus value at 20° C. has been given.

The material of example 4 behaves like the material of example 2. The material of example 5 has an advantageous behavior given that it does not flow significantly beyond the glass transition of the poly(methyl methacrylate) blocks. Furthermore, the value of the modulus plateau above the T_{g} of the poly(methyl methacrylate) blocks is much higher than in the other blends of the same composition.

The solvent resistance of these extruded samples with a ratio R=70:30 was tested by immersing parts originating from extrudates in chloroform for several days. The chloroform resistance increases with the size of the PA grafts used: the shape of the sample persists and the swelling decreases. This is characteristic of good connectivity of the PA through the sample. These observations can be correlated with the thermomechanical analysis results (FIG. 5).

The materials with PA6 of higher mass (PA3) therefore made it possible to obtain materials where the PA is very finely dispersed and which have advantageous properties.

### Examples 6 to 8

### Preparation of P(MMA_{f}-b-BA-b-MMA_{f}): PA3 Copolymers by Reactive Extrusion

The copolymers of the title, with R=80:20 (example 6), R=50:50 (example 7) and R=30:70 (example 8), were prepared under the conditions indicated above.

The materials (extrudates) obtained are relatively transparent, with the exception of the material of example 8.

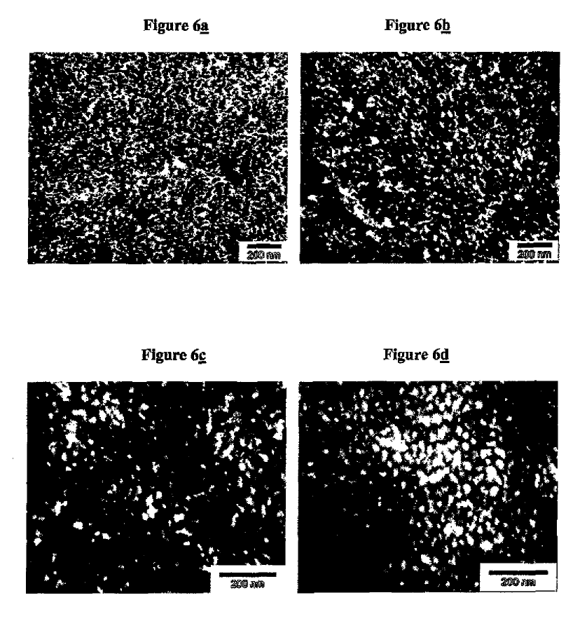

The TEM micrographs of the materials of examples 6, 5, 7 and 8, annealed for 1 hour at 235° C. under vacuum, are given in FIGS. 6a to 6d (labeling with PTA), respectively.

When the PA content increases in the blend, the morphology remains very fine and homogeneous. The morphology also changes with the PA content. For 70% of PA, there is in fact a tendency to disperse the P(MMA_{f}-b-BA-b-MMA_{f}) in the PA (FIG. 6d); consequently, the product obtained is white. Conversely, when the PA represents only 20% of the blend, nodules of PA can be observed (FIG. 6a).

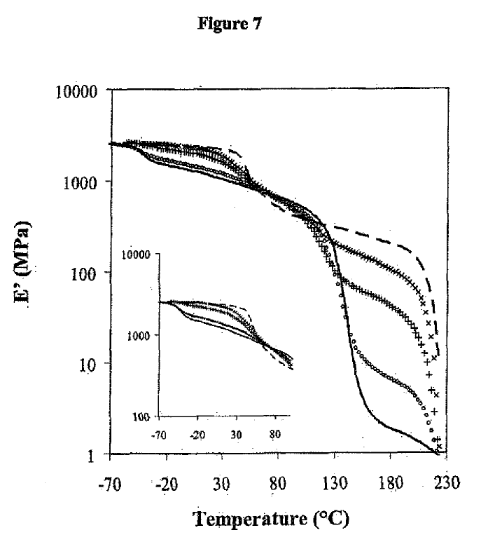

The curves of change in storage modulus as a function of temperature are given in FIG. 7 for P(MMA_{f}-b-BA-b-MMA_{f}), the materials of examples 5, 7 and 8 and the PA3:
P(MMA_{f}-b-BA-b-MMA_{f}): solid line
graft copolymer material of example 5: oooooooooooo
graft copolymer material of example 7: ++++++++++++
graft copolymer material of example 8: _{gg}xx
PA3: dotted line

In table 1 hereinafter, the storage modulus values at 20° C. and at 180° C. have been given for these five materials. The modulus at ambient temperature and at the plateau at 180° C. increases with the PA content.

In addition, it emerges from FIG. 7 that the PA behavior at around 80° C. is improved.

### CONCLUSION

The graft triblock materials of the invention exhibit fine and homogeneous morphologies, irrespective of the size of the PA chains used. The content of graft triblock copolymer is high and the residual P(MMA_{f}-b-BA-b-MMA_{f}) and PA polymers are well incorporated into the structure. Furthermore, the morphology of the blends virtually does not change during annealing (1 h at 235° C. under vacuum). These results differ from those obtained in the absence of the central PBA block. The structuring of the P(MMA_{f}-b-BA-b-MMA_{f}) therefore plays an important role with respect to the grafting process and with respect to the stability of the blends obtained.

The properties of these blends were studied by DMA and by immersing the rods in a good solvent for the triblock. The best thermomechanical and solvent-resistance properties are observed in the case of the blends extruded with PA6 of high mass (15 000 g/mol). This is reflected, in DMA, by a higher modulus under ambient conditions, a material that is stable up to the T_{g} of the PMMA blocks and a high modulus until melting of the PA for the blends having a PA content of 70% by mass.

TABLE 1
Value of the storage modulus (E′) at 20° C. or at 180° C.

| | (E′) at 20° C. | (E′) at 180° C. |
|---|---|---|
| Example | (in MPa) | (in MPa) |
| Reference P(MMA_{f}-b-BA-b-MMA_{f}) | 1105 | |
| 1 (PA = PA1; R = 80:20) | 1105 | |
| 2 (PA = PA1; R = 70:30) | 1260 | |
| 3 (PA = PA1; R = 60:40) | 1315 | |
| 4 (PA = PA2; R = 70:30) | 1105 | |
| 5 (PA = PA3; R = 70:30) | 1270 | 6 |
| 7 (PA = PA3; R = 50:50) | 1770 | 42 |
| 8 (PA = PA3; R = 30:70) | 2055 | 105 |
| PA3 | 2265 | 200 |

1. A graft copolymer composed of a backbone formed from a block copolymer of general formula:
B-(A)ₙ
in which:
A is a rigid polymer block with a glass transition temperature of more than 0° C.;
B is a flexible polymer block with a glass transition temperature of less than 0° C.; and
n is 1 or is a natural integer greater than 1,
it being possible for the blocks A, when n is 2 or more, to be identical or different; and of polyamide (PA) grafts which are carried by the rigid polymer block(s), the resulting graft copolymer being represented by the general formula:
(A_{g})ₘ-B-(A)ₚ
in which:
A and B are as defined above;
A_{g} is the block A carrying at least one graft (PA); and
m and p are natural integers, the sum of which is equal to n, but it being possible for p to be equal to 0.

2. The graft copolymer as claimed in claim 1, wherein n is 1 or is a natural integer from 2 to 20.

3. The graft copolymer as claimed in claim 1, wherein, when n is at least 2, all the blocks A are identical and/or all the blocks A_{g} are identical.

4. The graft copolymer as claimed in claim 1, wherein:
the number-average molecular mass of each block A is between 5000 and 100 000 g/mol;
the number-average molecular mass of the block B is between 5000 and 100 000 g/mol; and
the number-average molecular mass of the polyamide grafts is between 1000 and 50 000 g/mol.

5. The graft copolymer as claimed in claim 1, wherein the ratio by mass of the copolymer B-(A)ₙ to the polyamide (PA) grafts is from 10:90 to 95:5.

6. The graft copolymer as claimed in claim 1, wherein each block A is a block of polymer having a glass transition temperature of greater than or equal to 50° C.

7. The graft copolymer as claimed in claim 1, wherein the block B is a block of polymer having a glass transition temperature of less than or equal to −10° C.

8. The graft copolymer as claimed in claim 1, wherein each block A is a methacrylic block, comprising predominantly methyl methacrylate (MMA) units.

9. The graft copolymer as claimed in claim 8, wherein each block A comprises from 70% to 99.5% by weight, of MMA units.

10. The graft copolymer as claimed in claim 1, wherein each block A comprises at least one unit carrying at least one function selected from the group consisting of acid, acid-salt, anhydride and epoxide functions.

11. The graft copolymer as claimed in claim 10, wherein each unit carrying at least one function chosen from acid, acid-salt, anhydride and epoxide functions is chosen from:
the units derived from at least one monomer comprising a C═C double bond, copolymerizable with the main monomer forming the block A and carrying at least one function chosen from acid, acid-salt, anhydride and epoxide functions; and
the glutaric anhydride units of formula: 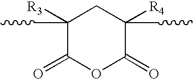
in which R₃ and R₄ denote H or a methyl radical.

12. The graft copolymer as claimed in claim 11, wherein each block A comprises at least one glutaric anhydride unit and/or at least one acrylic acid unit and/or at least one methacrylic acid unit.

13. The graft copolymer as claimed in claim 1, wherein the or each block A comprises, by weight, from 0.5% to 30%, of the unit(s) carrying at least one acid, acid-salt, anhydride or epoxide function.

14. The graft copolymer as claimed in claim 1, wherein the or each block A comprises at least one unit of a comonomer (a) having at least one C═C double bond, copolymerizable with the main monomer forming said block and which does not carry an acid, acid-salt, anhydride or epoxide function.

15. The graft copolymer as claimed in claim 14, wherein the comonomer (a) is chosen from the following monomers:
the acrylic monomers of formula CH₂═CH—C(═O)—O—R₁ where R₁ denotes a linear, cyclic or branched C₁-C₄₀ alkyl group optionally substituted with a halogen atom or a hydroxyl, alkoxy or cyano group;
the methacrylic monomers of formula CH₂═C(CH₃)—C(═O)—O—R₂ where R₂ denotes a linear, cyclic or branched C₂-C₄₀ alkyl group optionally substituted with a halogen atom or a hydroxyl, alkoxy, cyano, amino or epoxy group; and
vinylaromatic monomers.

16. The graft copolymer as claimed in claim 1, wherein each block A is MMA-based and comprises, by weight:
from 70% to 99.5% of MMA;
from 0 to 20% of a comonomer (a) having at least one C═C double bond, copolymerizable with MMA and which does not carry an acid, acid-salt, anhydride or epoxide function;
from 0.5% to 30% of at least one group carrying at least one acid, acid-salt, anhydride or epoxide function.

17. The graft copolymer as claimed in claim 16, wherein each block A is MMA-based and comprises, by weight:
from 80% to 99.5% of MMA;
from 0 to 10% of a comonomer (a) having at least one C═C double bond, copolymerizable with MMA and which does not carry an acid, acid-salt, anhydride or epoxide function;
from 0.5% to 20% of at least one group carrying at least one acid, acid-salt, anhydride or epoxide function.

18. The graft copolymer as claimed in claim 17, wherein the or each MMA-based block A comprises, by weight:
from 85% to 99.5% of MMA;
from 0 to 5% of a comonomer (a) having at least one C═C double bond, copolymerizable with MMA and which does not carry an acid, acid-salt, anhydride or epoxide function; and
from 0.5% to 15% of at least one group carrying at least one acid, acid-salt, anhydride or epoxide function.

19. The graft copolymer as claimed in claim 1, wherein the block B comprises butyl acrylate units or predominantly butyl acrylate units.

20. The graft copolymer as claimed in claim 1, wherein the polyamide forming the grafts is selected from the group consisting of PA 6, PA 6-6, PA 11, PA 12 and copolymers thereof.

21. The graft copolymer as claimed in claim 20, wherein the polyamide has a melting point of between 100 and 400° C.

22. The graft copolymer as claimed in claim 1, wherein there are, per block A_{g}, on average from 1 to 100 polyamide (PA) grafts.

23. The graft copolymer as claimed claim 1, consisting a triblock copolymer A_{g}-B-A_{g}.

24. A process for preparing a graft copolymer as defined in claim 1, consisting of the step of reacting, with a polyamide terminated with a primary-amine or acid function, a copolymer of general formula B-(A)ₙ, A, B and n in which:
A is a rigid polymer block with a glass transition temperature of more than 0° C.;
B is a flexible polymer block with a lass transition temperature of less than 0° C.; and
n is 1 or is a natural integer greater than 1,
it being possible for the blocks A, when n is 2 or more, to be identical or different; and of polymide (PA) grafts which are carried by the rigid polymer block(s), the resulting graft copolymer being represented by the general formula:
(A_{g})ₘ-B-(A)ₚ
in which:
A and B are as defined above;
A_{g} is the block A carrying at least one graft (PA); and
m and p are natural integers, the sum of which is equal to n, but it being possible for p to be equal to 0, and the block(s) A carrying functionalities capable of reacting with primary-amine or acid functions of the polyamide.

25. The process as claimed in claim 24, wherein said reaction is carried out by reactive extrusion at a temperature of from 180 to 320° C. for a period of time of 1 second to 15 minutes.

26. A material composed:
of graft copolymer (A_{g})ₘ-B-(A)ₚ as defined in claim 1, in a proportion in particular of 10% to 98% by weight;
of copolymer B-(A)ₙ which has not reacted, B-(A)ₙ being as defined in claim 1, the block(s) A carrying functionalities capable of reacting with primary-amine or acid functions, in a proportion in particular of 1% to 50% by weight;
of 1% to 50% by weight of polyamide terminated with a primary-amine or acid function which has not reacted, in a proportion in particular of 1% to 50% by weight;
the total coming to 100% by weight.

27. The material as claimed in claim 26, further comprising from 0 to 60% by weight of impact modifier of core-shell type, relative to the material.

28. The material as claimed in claim 26 comprising films, blow-molded parts, injected parts, or extruded sheets.

29. The material of claim 26 comprising, a compatibilizing agent for obtaining an alloy based on a polyamide and on a polymer chosen from polymethyl methacrylate (PMMA), polyvinylidene fluoride (PVDF), polyvinyl chloride (PVC) and acrylic polymers.

30. The material as claimed in claim 29 comprising a coextrusion binder for a multilayer structure based on polyamide and on a polymer chosen from PMMA, PVDF, PVC and acrylic polymers, having, in the following order, the following layers:
a layer c1 of polyamide;
a layer c2 of the material;
a layer c3 of a polymer chosen from PMMA, PVDF, PVC and acrylic polymers; the layers adhering to one another.
